(19) United States
(12) Patent Application Publication
(10) Pub. No.: US 2022/0363962 A1
(43) Pub. Date: Nov. 17, 2022

(54) UV OR EB CURABLE MULTIFUNCTIONAL TALL OIL (METH)ACRYLATES

(71) Applicant: Ingevity South Carolina, LLC, North Charleston, SC (US)

(72) Inventors: Mitra Ganewatta, Ladson, SC (US); Chenxi Zhang, Mt. Pleasant, SC (US); Yongning Liu, Apex, NC (US)

(21) Appl. No.: 17/741,962

(22) Filed: May 11, 2022

Related U.S. Application Data
(60) Provisional application No. 63/188,236, filed on May 13, 2021.

(51) Int. Cl. C09J 163/00; C09J 175/04; C09J 5/06; C09D 11/104; C09D 11/101

(52) U.S. Cl. CPC C09J 163/00; C09J 175/04; C09J 5/06; C09D 11/104; C09D 11/101

(57) ABSTRACT

Presently described are energy-curable resins, compositions, thermosets, coatings, and methods thereof. The curable resins described herein are (meth)acrylated resins derived from distilled tall oil rosin acids, distilled tall oil fatty acids, or a combination thereof. The curable resins can also include derivatives from rosin acids and/or fatty acids, such as cycloaddition products. The curable compositions undergo fast curing using UV and/or EB and provide enhanced performance of coatings, films, and printing inks, especially adhesion, stability and flexibility.

### CROSS REFERENCE TO RELATED APPLICATION

This application claims priority to U.S. Provisional Application No. 63/188,236, filed May 13, 2021, the content of which is herein incorporated by reference in its entirety.

### BACKGROUND

### Field of the Discovery

The present disclosure relates to curable compositions including curable resins including the reaction product of a distilled tall oil rosin acid or derivative thereof, a distilled tall oil fatty acid or derivative thereof, or a combination thereof. These multifunctional and solventless resins are used to in energy-curable compositions and can enhance the performance of coatings, films, and printing inks. The disclosure also provides methods of making curable resins, methods for making the curable compositions, thermosets of the curable compositions, coatings including the curable compositions, and pigment dispersions including the curable compositions.

### Background Information

Thermosetting compositions, such as unsaturated polyesters, vinyl esters, and epoxy resins have been widely used in coatings, adhesives and composite materials. Historically, curable compositions have been synthesized using petroleum-based chemicals as raw materials. However, due to increasing environmental concerns, there is a need for curable compositions derived from bio-based feedstocks.

Bio-based feedstocks include fatty acids derived from plant-based oils including but not limited to soybean oil, canola oil, tall oil, safflower oil, linseed oil, castor oil, corn oil, sunflower oil, olive oil, sesame oil, cottonseed oil, palm-based oils, rapeseed oil, tung oil, peanut oil, jatropha oil, and combinations thereof. Other bio-based feedstocks include rosin acids including gum rosin acid, wood rosin acid, tall oil rosin acid, or a combination thereof.

Rosin, a bio-renewable raw material, is commercially available, and can be obtained from pine trees by distillation of oleoresin (gum rosin being the residue of distillation), by extraction of pine stumps (wood rosin) or by fractionation of tall oil (tall oil rosin). Rosin contains a mixture of rosin acids, fatty acids, and other unsaponifiable compounds. These when used in resins can improve adhesion, glass transition temperature, thermal stability, hydrophobicity, and ink dispersion properties.

Tall oil rosin, a type of rosin (originating from the Swedish word “tallolja” (“pine oil”)) is obtained as a by-product of Kraft pulping in the paper making process. A product of the Kraft process, crude tall oil (CTO), can be further purified by distillation to provide tall oil heads, tall oil fatty acids (TOFA), tall oil rosin (TOR), and tall oil pitch. During the fractional distillation process, another product is isolated between the tall oil and rosin fractions, known as distilled tall oil (DTO). DTO is a mixture of tall oil fatty acids and rosin acids. DTO provides the benefits of room temperature liquidity, while pure rosin is a solid and difficult to handle without proper heating capabilities. These products have long been used in traditional fields such as inks, adhesives, oil fields, mining, paper sizing and detergents.

In applications such as inks, adhesive and coatings, it is desirable to cure energy-curable resin compositions using ultraviolet (UV) and/or electron beam (EB) energy. These methods are appealing due to the reduction of air pollution, waste, and energy consumption, while increasing productivity. Typically, the resin compositions include oligomers, monomers, polymers, photo-initiators and various additives such as antioxidants, pigments, and plasticizers. Acrylate terminal functional groups are commonly used for EB or UV curing systems as they undergo fast free-radical induced polymerization/crosslinking when exposed to radiation. Acrylate-functionalized energy-curable resins include polyester and epoxy resins, aliphatic and aromatic urethanes, silicones, and polyethers. Each class of these acrylate-functionalized energy-curable resins provide different costs and performance benefits such as stability, flexibility, impact resistance, gloss, pigment wetting, and chemical resistance. Acrylate-functionalized energy-curable resins are derived from monofunctional, difunctional, trifunctional and higher functional monomers.

Epoxy acrylates are highly regarded in commercial energy curing systems. They are extensively used in lithographic inks and varnishes and coatings for substrates such as, wood, concrete, and plastic and for printed circuit boards and automotive applications. In particular, the presence of polar hydroxyl and ether groups in the epoxy backbone structure of the epoxy acrylates provide adhesion performance and fast cure rates.

Conventional commercially available epoxy (meth)acrylate oligomers are based on the diglycidyl ether of bisphenol A (DGEBA). In particular, the aromatic resin bisphenol A (BPA) epoxy acrylates and polyester acrylates may be based with BPA, and/or ethoxylated BPA diacrylate are widely used for their fast cure, gloss, chemical resistance, hardness, high tensile strength and modulus, and low elongation. However, BPA is a xenoestrogen (estrogen mimic) and not suitable for human contact applications such as food packaging. Because BPA-containing thermosets are prone to hydrolysis, leading to environmental and safety concerns, it has become preferable to minimize or exclude aromatic resins such as BPA from energy-curable compositions in consumer applications (e.g., food and drink containers and medical supplies).

BPA-free curable resins where performance is maintained as compared to conventional BPA-containing epoxy acrylates are desirable. However, bio-based epoxy acrylates, such as, for example, acrylated soya or linseed oil have several deficiencies such as lower viscosity, poor mechanical performance, and increased manufacturing costs. Similarly, bio-based (meth)acrylate monomers, where the monomer includes a rosin or isosorbide moiety obtained from natural sources is disclosed in Canadian Patent No. 2909942C. The disclosed monomers are synthesized utilizing a bio-based moiety comprising a hydroxyl group (—OH) or an acid group (—COOH) that is reacted with an epoxy acrylate or epoxy methacrylate to generate a monofunctional bio-based acrylate or methacrylate monomer, which can then be polymerized with comonomers such as styrene, methacrylic acid and/or dimethylaminoethyl methacrylate to control the glass transition temperature and hydrophobicity of the polymeric resin. However, because this approach uses a monofunctional bio-based acrylate or methacrylate monomer, the cured compositions may have a low glass transition temperature and/or inadequate chemical resistance for certain applications.

U.S. Pat. No. 7,923,531 discloses the preparation of acrylate functionalized gum rosin under mild reaction conditions, wherein sterically-hindered hydroxyl groups of the gum rosin ester are reacted with 3-chloropropionic acid, and the resulting ester undergoes dehydrohalogenation to provide an acrylate functionalized gum rosin. The gum rosin ester is the product of an esterification of a maleic anhydride modified rosin with a polylol. The advantage of this approach is two-fold: the amount of acylation is desirably increased, while avoiding the harsh reaction conditions usually required to acylate the sterically-hindered hydroxyl groups. The harsh reaction conditions cause undesired polymerization of the acrylic functions at high temperatures due to their thermal instability.

Similarly, Chinese Patent No. 101492591 discloses the esterification of a rosin acid with a polylol and functionalizing the available polyol groups as acrylates. However, the methods disclosed in Chinese Patent No. 101492591 employs harsh chemicals that are difficult to scale-up in manufacturing plants and also produce toxic waste.

PCT Publication WO2001038446 describes the preparation of rosin-modified epoxy acrylates using aromatic and aliphatic epoxy diglycidyl ethers, including BPA epoxy resins. However, the rosin loading is only 8 wt % and the synthesis requires a dispersant. Furthermore, skilled artisans recognize that this route results in nonfunctional molecules and monofunctional acrylates at best where one rosin molecule and one acrylic acid reacts with an epoxy diglycidyl ether. This is a major drawback for cured resin performance because monofunctional acrylates act as chain stoppers during the polymerization and prevent cross-link formation. Significant amounts of polyol acrylates such as pentaerythritol ethoxy tetra acrylate are needed in the formulation to improve the cross-linking and hence the mechanical properties.

Previous attempts have been made to incorporate fatty acids into curable compositions to improve flexibility of the thermoset and processability or the curable composition. Using fatty acids alone in energy-curable compositions may reduce mechanical strength and thermal stability of the thermoset. Using only rosin acid alone in energy-curable compositions may lead to a brittle coatings or resins or highly viscous liquids that are difficult to handle. One way to improve the mechanical strength and flexibility of an energy-curable resin is to incorporate an additional difunctional or multifunctional resin, which can be functionalized with (meth)acrylate terminal functional groups. Advantageously, the presence of multiple highly reactive (meth)acrylate moieties allows for rapid crosslinking polymerization to provide a tack-free surface.

Accordingly, there remains a need in the art for curable compositions derived from bio-based components that provide improved energy cure, mechanical strength, thermal and chemical stability, good toughness and flexibility while minimizing or eliminating the need for aromatic resins derived from aromatic monomers such as BPA-based monomers.

### SUMMARY

Presently described are energy-curable resins, in particular UV or EB curable resins, curable compositions, and thermosets, each derived from distilled tall oil rosin acids, distilled tall oil fatty acids, derivatives thereof, and their mixtures thereof. The curable compositions comprising the curable resins described herein provide good processability and provide thermosets having a wide range of glass transition temperatures and improved adhesion, flexibility, and ink dispersion properties.

Surprisingly, the inventors hereof discovered that distilled tall oil rosin acids and/or distilled tall oil fatty acids and distilled tall oil rosin acid derivatives and/or distilled tall oil fatty acid derivatives derived from Diels-Alder or Ene modified can be used without gelation to produce BPA-free multifunctional acrylate monomers, oligomers, and polymers with a high degree of (meth)acrylate group incorporation, while maintaining liquid and workable viscosities at room temperature. This was achieved via the functionalization of the modified or unmodified carboxylic acid substrates (i.e., rosin acids, fatty acids) derived from distilled tall oil with a multifunctional glycidyl ether component (e.g., di, tri, or higher functionalized epoxies such as triglycidyl ethers) and functionalizing the remaining epoxy groups with polymerizable acids such as acrylic acid to produce monomeric, oligomeric, and/or polymeric multifunctional acrylates. Unexpectedly, these curable resins when incorporated into curable compositions provided fast curing properties, superior adhesion, and flexibility while maintaining excellent gloss, tack, hardness, rub-resistance and blocking resistance in energy-curable coating applications.

Thus, in an aspect the disclosure provides a curable resin comprising a reaction product of: a distilled tall oil rosin acid or a derivative thereof, a distilled tall oil fatty acid or a derivative thereof, or a combination thereof a multifunctional glycidyl ether component comprising at least two glycidyl ether groups; a catalyst; and a (meth)acrylate terminal functional group precursor, optionally comprising a rosin acid or derivative thereof, a fatty acid or a derivative thereof, or a combination thereof, each derived from gum tree rosin, wood rosin, softwood rosin, hardwood rosin, a natural oil, or a combination thereof, wherein the curable resin has at least one terminal functional group comprising (meth)acrylate.

In any of the aspects or embodiments described herein, a method for preparing a curable resin is disclosed comprising the steps of: reacting the a distilled tall oil rosin acid or a derivative thereof and/or the distilled tall oil fatty acid or derivative thereof, with a multifunctional glycidyl ether component comprising at least two glycidyl ether groups in the presence of a catalyst to provide the ring-opened first intermediate; and reacting the ring-opened first intermediate with an a (meth)acrylate terminal functional group precursor in the presence of a catalyst to provide the curable resin.

In any of the aspects or embodiments described herein, a curable composition is disclosed comprising the curable resin; a catalyst; and optionally, an energy-curable monomer, oligomer, polymer, or a combination thereof, a photoinitiator, an auxiliary curable resin, a synergist, a pigment, or a combination thereof.

In any of the aspects or embodiments described herein, a thermosets comprising the curable composition is disclosed having superior adhesion and flexibility while maintaining excellent gloss, tack, hardness, rub-resistance and blocking resistance in energy-curable coating applications.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the present disclosure can be utilized in numerous combinations, all of which are expressly contemplated by the present disclosure. These additional advantages objects and embodiments are expressly included within the scope of the present disclosure. The publications and other materials used herein to illuminate the background of the invention, and in particular cases, to provide additional details respecting the practice, are incorporated by reference.

### DETAILED DESCRIPTION

The present disclosure will now be described more fully hereinafter, but not all embodiments of the disclosure are shown. While the disclosure has been described with reference to exemplary embodiments, it will be understood by those skilled in the art that various changes can be made and equivalents can be substituted for elements thereof without departing from the scope of the disclosure. In addition, many modifications can be made to adapt a particular structure or material to the teachings of the disclosure without departing from the essential scope thereof.

Where a range of values is provided, it is understood that each intervening value between the upper and lower limit of that range and any other stated or intervening value in that stated range is encompassed within the invention. The upper and lower limits of these smaller ranges can independently be included in the smaller ranges is also encompassed within the invention, subject to any specifically excluded limit in the stated range. Where the stated range includes one or both of the limits, ranges excluding either both of those included limits are also included in the present disclosure.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the 10 United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

Consistent with the plain and ordinary meaning attributed by those of skill in the art, and unless the context indicates otherwise, the term “resin” refers to a solid or highly viscous substance of plant or synthetic origin that is typically convertible into a polymer.

### Exemplary Aspects and Embodiments

Surprisingly and unexpectedly, the inventors discovered that curable resins and/or curable compositions derived from distilled tall oil can have desirable properties for various applications when aromatic resins such as BPA are minimized or eliminated. These curable compositions can include a curable resin; and optionally, a photoinitiator, an energy-curable monomer, oligomer, polymer, or a combination thereof, an auxiliary curable resin, a synergist, a pigment, or a combination thereof. The curable resin comprises a reaction product of a distilled tall oil rosin acid or derivative thereof, a distilled tall oil fatty acid or derivative thereof, or a combination thereof, a multifunctional glycidyl ether component comprising at least two glycidyl ether groups; a catalyst; and optionally comprising a rosin acid or derivative thereof, a fatty acid or a derivative thereof, or a combination thereof, each derived from gum tree rosin, wood rosin, softwood rosin, hardwood rosin, a natural oil, or a combination thereof; a (meth)acrylate terminal functional group precursor to provide a curable resin having at least one terminal functional group comprising (meth)acrylate. In the curable compositions, the curable resin and the optional energy-curable monomer, oligomer, polymer, or a combination thereof each have terminal functional groups. In the presence of energy and optionally a photoinitiator (e.g., UV and/or EB), the terminal functional groups can undergo polymerization and cross-linking to provide a thermoset. Advantageously, the thermosets have a high content of bio-based materials and have comparable properties to fully petroleum-based thermosets, while minimizing or eliminating aromatic resins such as BPA or volatile monomers.

Advantageously, when the curable resin comprises a distilled tall oil rosin acid derivative, a distilled tall oil fatty acid derivative, or a combination thereof, wherein the derivatives are each products from a cycloaddition reaction such as a Diels-Alder or Alder-Ene reaction of a distilled tall oil rosin acid, a distilled tall oil fatty acid, or a combination thereof, then the curable resins are liquid and workable at room temperature, so a solvent or dispersant is not needed. For UV and EB curable compositions, it is preferred that solvents and dispersants not be used in their preparation. Added solvents require removal before the curing process, thus adding to manufacturing cost and time, whereas dispersants can adversely affect the curing process and/or the adversely affect the compositions that include pigments.

The disclosed methods relate to methods for preparing curable resins derived from distilled tall oil; methods for preparing curable compositions from the curable resins; methods for coating a substrate with the curable compositions; methods for making the ink dispersion compositions; and methods for curing the curable compositions to provide thermosets.

As described above, conventional curable compositions derived from 100% bio-based feedstocks suffer from well-known disadvantages including too-low or too-high viscosity of the curable compositions and brittleness and poor mechanical properties of thermosets derived from 100% bio-based feedstocks.

Thus, in an aspect, the description provides a curable resin comprising: a distilled tall oil rosin acid or a derivative thereof, a distilled tall oil fatty acid or a derivative thereof, or a combination thereof, ; a multifunctional glycidyl ether component comprising at least two glycidyl ether groups, a catalyst; a (meth)acrylate terminal functional group precursor, and optionally comprising a rosin acid or derivative thereof, a fatty acid or a derivative thereof, or a combination thereof, each derived from gum tree rosin, wood rosin, softwood rosin, hardwood rosin, a natural oil, or a combination thereof, wherein the curable resin has at least one terminal functional group comprising a (meth)acrylate.

In an aspect, the description provides a curable resin comprising: a cycloaddition reaction product of a distilled tall oil rosin acid or a derivative thereof, a distilled tall oil fatty acid or a derivative thereof, or a combination thereof a multifunctional glycidyl ether component comprising at least two glycidyl ether groups; a catalyst and a (meth)acrylate terminal functional group precursor, optionally comprising a rosin acid or derivative thereof, a fatty acid or a derivative thereof, or a combination thereof, each derived from gum tree rosin, wood rosin, softwood rosin, hardwood rosin, a natural oil, or a combination thereof, wherein the curable resin has at least one terminal functional group comprising a (meth)acrylate.

In an aspect, the description provides a curable composition comprising a curable resin; optionally, an energy-curable monomer, oligomer, polymer, or a combination thereof, wherein the energy-curable monomer has at least one terminal functional group comprising an acrylate; a photo initiator, and optionally, an energy-curable monomer, a curing synergist, a pigment, or a combination thereof.

In any of the aspects or embodiments described herein, the curable resin and the curable compositions include a distilled tall oil rosin acid or a derivative thereof, a distilled tall oil fatty acid, or a derivative thereof, or a combination thereof.

Rosin acids include C₂₀ mono-carboxylic acids with a core having a fused carbocyclic ring system comprising double bonds that vary in number and location. Examples of rosin acids include abietic acid, neoabietic acid, pimaric acid, levopimaric acid, sandaracopimaric acid, isopimaric acid, and palustric acid. TOR can further contain dimerized rosin acids and dehydroabietic acids formed during the Kraft process and distillation of CTO.

TOFA includes a complex mixture of fatty acids, including, e.g., palmitic, stearic, oleic, elaidic, linoleic, and linolenic acids; and small quantities of rosin.

Distilled tall oil, which includes fatty acids and rosin acids, can have a variable rosin acid content. The rosin acids and fatty acids can be present in the distilled tall oil from about 1 wt % to about 99 wt %, about 10 wt % to about 90 wt %, about 20 wt % to about 70 wt %, about 28 wt % to about 70 wt %, about 30 wt % to about 70 wt %, about 35 wt % to about 70 wt %, 40 wt % to about 70 wt %, about 45 wt % to about 70 wt %, or about 50 wt % to about 70 wt %, each based on the total weight of the distilled tall oil. Commercially available DTOs with variable rosin acid content include Altapyne® 226 (25 wt % rosin acid), Altapyne® M-28B (30 wt % rosin acid), Altapyne™ M-50 (50 wt % rosin acid), and Altapyne® M-70 (70 wt % rosin acid) (all from Ingevity, S.C.). These or others can also be blended with rosin such as Altapyne™ Rosin SS-A, Altapyne™ Rosin R-24, Lytor® 100 or TOFA such as Altapyne® L-1 and Altapyne® L-5 (all from Ingevity, S.C.) to change the rosin or TOFA content and modulate viscosity.

The disclosed curable resins and compositions can include rosin acid derivatives and/or fatty acid derivatives derived from distilled tall oil. Rosin acid derivatives and/or fatty acid derivatives can include Diels-Alder or Alder-Ene adducts. Diels-Alder cycloaddition can be used to form what are commonly called “rosin adducts” from rosin acids and “fatty acid adducts” from fatty acids. Diels-Alder adduction occurs with s-cis conjugated double bonds, or double bonds capable achieving a conjugated s-cis configuration. For example, abietic-type rosin acids undergo Diels-Alder adduction. Among the fatty acids present in tall oil products, oleic acid, linoleic acid, linolenic acid have double bonds capable of undergoing an ene reaction (as is the case for oleic acid because it has a single double bond) or Diels-Alder cycloaddition (for linoleic acid and linolenic acid).

Non-limiting exemplary dienophiles that can be used to react with conjugated dienes include maleic anhydride, fumaric acid, itaconic acid or anhydride, and acrylic acid. Diels-Alder products obtained from the reaction of maleic anhydride with a rosin acid or a fatty acid have three carboxylic acid groups and are referred to as “maleated rosin” and “maleated fatty acid,” respectively. Similarly, Diels-Alder products obtained from the reaction of fumaric acid with a rosin acid or a fatty acid have three carboxylic acid groups and are referred to as “fumarated rosin” and “fumarated fatty acid,” respectively. The molar amount of dienophile (e.g., fumaric acid) used in the Diels Alder reaction can range from about 1 to about 40 mol %, 1 to about 30 mol %, about 5 to about 25 mol %, or about 10 to about 25 mol %, each based on the total moles of acid in the diene (e.g., rosin acids+fatty acids in DTO).

Rosin acid derivatives and fatty acid derivatives can include dimers. The double bonds of rosin acids can react with each other to form rosin dimers. Similarly, the double bonds of fatty acids can react with each other to form fatty acid dimers. Rosin dimer molecules include a C₄₀-terpene typically having two double bonds and two carboxylic acid groups. Rosin dimerization can be controlled to obtain appropriate levels of dimerization; hence the dimer rosin product may be a mixture of rosin and dimerized-rosin molecules. A TOFA dimer acid includes a C₃₆ dicarboxylic acid molecule. Similarly, trimer acids are available in the mixture.

Rosin acid derivatives and fatty acid derivatives can include dehydrogenation products, also referred to as disproportionation products. For example, this process can be used to reduce the conjugated double bonds in some rosin acids, making the resulting disproportionated rosin less susceptible to oxidation. The reaction takes places between the dienes of two identical rosin acids, where one is hydrogenated and the other is dehydrogenated, thus altering the ratios of the rosin acids from the untreated rosin. Similarly, fatty acid derivatives can include disproportionation products (e.g., oleic acid).

In some embodiments, the rosin acid derivatives include a disproportionated rosin, a maleated rosin, a fumarated rosin, adduct, itaconic acid adduct, an acrylic acid adduct, a dimer acid, or a combination thereof.

In addition to the rosin acids and/or fatty acids derived from distilled tall oil, the curable resins and compositions can include additional rosin acids and/or fatty acids derived from bio-based components such as wood rosin, gum rosin, natural oils, or a combination thereof. In some embodiments, the additional fatty acid is derived from at least one of a natural oil, crude tall oil, coconut oil, palm oil, rosin, gum tree rosin, wood rosin, softwood rosin, hardwood rosin, derivatives thereof, or a combination thereof. Non-limiting exemplary natural oils include vegetable oil, safflower oil, sesame oil, canola oil, olive oil, oil, coconut oil, soybean oil, linseed oil, castor oil, corn oil, sunflower oil, cottonseed oil, palm-based oils, rapeseed oil, tung oil, peanut oil, and jatropha oil. In some embodiments, the additional rosin acid is derived from crude tall oil, rosin, gum tree rosin, wood rosin, softwood rosin, hardwood rosin, derivatives thereof, or a combination thereof.

The curable resin includes a multifunctional glycidyl ether component. In some embodiments, the multifunctional glycidyl ether includes monomeric oligomeric, and polymeric forms of triglycidyl ethers, tetraglycidyl ethers, or a combination thereof. The triglycidyl ether can include monomeric, oligomeric and/or polymeric trimethylolpropane triglycidyl ether and the tetraglycidyl ether can include monomeric, oligomeric and/or polymeric pentaerythritol tetraglycidyl ether.

The terminal functional groups of the curable resin include (meth)acrylate functional groups. As used herein, the expression “(meth)acrylate” refers to “acrylate or methacrylate.” In one embodiment the (meth)acrylate is an acrylate. In another embodiment the (meth)acrylate is a methacrylate. Preferably, the (meth)acrylate is an acrylate. In the curable resin, the (meth)acrylate terminal functional group is introduced by reaction with a (meth)acrylate terminal functional group precursor. Exemplary (meth)acrylate terminal functional group precursors include methacrylic acid, acrylic acid, acid chlorides thereof, activated acids thereof, and the like.

The curable resin can be substantially free of repeating units derived from BPA epoxy monomers, oligomers, or polymers. As used herein “substantially free of BPA monomers, oligomers, or polymers” means that the curable composition comprises 10 wt % or less, 5 wt % or less, 1 wt % or less, 0.1 wt % or less of BPA monomers, oligomers, or polymers, based on the total weight of the curable resin. In some embodiments, the curable resin excludes repeating units derived from BPA epoxy monomers, oligomers, or polymers. In some embodiments, the curable resin excludes repeating units derived from the diglycidyl ether of bisphenol A.

The curable resin can be prepared by a method comprising the steps of: reacting the distilled tall oil rosin acid or a derivative thereof, the distilled tall oil fatty acid or a derivative thereof, or a combination thereof, with a multifunctional glycidyl ether component comprising at least two glycidyl ether groups in the presence of a catalyst to provide the ring-opened first intermediate; and reacting the ring-opened first intermediate with a (meth)acrylate terminal functional group precursor in the presence of catalyst to provide the curable resin. The molar ratio of a distilled tall oil rosin acid or a derivative thereof and/or the fatty acid or a derivative thereof to the multifunctional glycidyl ether component to the a (meth)acrylate terminal functional group precursor in the reaction can be from about 0.5:1:1 to about 1.5:1:1, more preferably from about 0.9:1:1 to about 1.1:1:1. curable resin.

A catalyst is present in the disclosed methods. The catalyst can include imidazole, amines, ammonium salts, organophosphine, urea derivatives and Lewis bases and their organic salts. Specifically, the catalyst can include trialkyl phosphines and triaryl phosphines, such as triphenyl phosphine or ammonium salts such as tetrabutylammonium bromide.

The ring-opening reaction of the epoxide ring of the multifunctional glycidyl ether component with the carboxylic acid of the distilled tall oil rosin acids and/or distilled tall oil fatty acids, or derivatives thereof, to form the ring-opened intermediate of the curable resin can be performed at a temperature from about 80 to about 160° C., preferably from about 100 to about 145° C. The reaction of the ring-opened intermediate of the curable resin with an a (meth)acrylate terminal functional group precursor can be performed at a temperature of from about 80 to about 115° C., preferably from about 100 to about 110° C. with suitable inhibitors.

In an exemplary embodiment, a curable resin comprises a reaction product of a distilled tall oil rosin acid or derivative thereof, a distilled tall oil fatty acid or a derivative thereof, or a combination thereof;, monomeric and/or oligomeric trimethylolpropane triglycidyl ether, monomeric and/or oligomeric pentaerythritol tetraglycidyl ether, or a combination thereof; a catalyst; and acrylic acid to provide the curable resin with at least one terminal group comprising acrylate.

The curable compositions include a curable resin; and optionally an energy-curable monomer, oligomer, polymer, or a combination thereof, an auxiliary curable resin, an energy-curable monomer, a curing synergist, a pigment, or a combination thereof, wherein the curable resin and the energy-curable monomer, oligomer, polymer, or a combination thereof, each have at least one terminal functional group.

The curable compositions can include an energy-curable monomer, oligomer, polymer, or a combination thereof. The energy-curable monomer, oligomer, or polymer has two or more terminal functional groups capable of polymerizing with the terminal functional groups of the other components (e.g., curable resin). In some embodiments, the energy-curable monomer excludes monofunctional monomers. Non-limiting exemplary energy-curable monomers include styrene, epoxies, and acrylates. Non-limiting examples of energy-curable acrylates include 1,4-butanediol diacrylate, 1,6-hexanediol diacrylate,1,6-hexanediol dimethacrylate, 1,9-nonanediol diacrylate, or a combination thereof. In some embodiments, energy-curable monomer, oligomer or polymer includes a urethane acrylate, an epoxy acrylate, or a combination thereof.

The curable compositions can be substantially free of a monofunctional energy-curable monomer. As used herein “substantially free of a monofunctional energy-curable monomers” means that the curable composition comprises 10 wt % or less, 5 wt % or less, 1 wt % or less, 0.1 wt % or less of monofunctional energy-curable monomers, based on the total weight of the curable composition. In some aspects, the curable compositions exclude monofunctional energy-curable monomers.

The curable composition can include an auxiliary curable resin comprising an aromatic resin, such as, for example, a bisphenol epoxy acrylate resin, a novolac epoxy acrylate resin, or a combination thereof. Bisphenol epoxy resins can be obtained from the reaction of a bisphenol with epichlorohydrin. The bisphenol epoxy resins can include bisphenol A epoxy resin, bisphenol F epoxy resin, or a combination thereof. Novolac epoxy resins are the reaction products of a phenolic compound such as phenol, o-, m-, or p-cresol, or a combination of these with an aldehyde, such as formaldehyde, benzaldehyde, acetaldehyde, and the like. For example, the novolac epoxy resin can be a phenol-formaldehyde copolymer, wherein the phenolic ring is substituted with a glycidyl ether group. These epoxy resins are reacted with acrylic acid to obtain epoxy acrylate resins.

The auxiliary curable resin can include urethane acrylate oligomers, which can be synthesized by reacting a diisocyanate with a polyester or polyether polyol to yield an isocyanate terminated urethane. Subsequently, hydroxy terminated acrylates are reacted with the terminal isocyanate groups. In some embodiments, the curable resin includes a hexafunctional aromatic urethane acrylate oligomer, such as CN975 from SARTOMER.

The curable compositions can be substantially free of a curable resin comprising BPA and/or novolac resin. As used herein “substantially free of BPA (meth)acrylates,” or “substantially free of novolac (meth) acrylates” means that the curable composition comprises 10 wt % or less, 5 wt % or less, 1 wt % or less, 0.1 wt % or less of BPA and novolac epoxy acrylate resins, respectively, based on the total weight of the curable composition. In some aspects, the curable compositions exclude curable resins. In certain aspects, the curable compositions exclude BPA and/or novolac epoxy acrylates. Not wishing to be bound by theory, the rigid ring structure of rosin component in the curable composition provides the desirable thermal properties such as high glass transition temperature and allows the full or partial replacement of BPA-based resin in the curable compositions.

The curable compositions may include a photoinitiator. In particular, the photoinitiator is preferably present when UV curing is used. In some embodiments the photo-initiator is a Type I photoinitiator. Not wishing to be bound by theory, Type I photoinitiators undergo bond cleavage following the absorption of light to give radicals which attack the double bonds of the polymerizable species, thereby initiating polymerization. In some embodiments the photo-initiator is a Type II photoinitiator. Not wishing to be bound by theory, Type II initiators, such as aromatic ketones, are compounds which, following absorption of light, generate radicals, either by hydrogen atom abstraction, or via electron transfer, followed by rapid proton transfer to generate radical species. An exemplary photoinitiator includes phenylbis(2,4,6-trimethylbenzoyl) phosphine oxide.

The curable compositions can include a curing synergist. The UV or EB curing of curable compositions can be performed in air. However, it may be desirable to minimize or eliminate the introduction of oxygen from the air into the curable compositions and thermosets. For example, during the UV or EB curing process, the radical intermediates may react with molecular oxygen, thereby decreasing the efficiency of the cure process (i.e., oxygen inhibition). A curing synergist may improve the efficiency of the curing process. Not wishing to be bound by theory, radicals generated from the amine curing synergist scavenge oxygen present in the curable composition, thereby allowing the curing process to proceed more efficiently.

The curing synergist may include a tertiary amine. Tertiary amines commonly used in UV and/or EB curing include either aliphatic amines, aliphatic amines, and hybrid amines (e.g., compounds containing both aliphatic and aromatic amine moieties). Non-limiting exemplary aliphatic amine synergists include N-methyldiethanolamine, N,N-dimethylethanolamine and triethanolamine. Non-limiting exemplary aromatic amine synergists include ethyl 4-N,N-dimethylaminobenzoate, and 2-ethylhexyl 4-N,N-dimethyl aminobenzoate.

In further embodiments, the curable compositions are substantially free of repeating units derived from BPA and/or repeating units derived from novolac. As used herein “substantially free of repeating units derived from BPA” means that the curable composition comprises 10 wt % or less, 5 wt % or less, 1 wt % or less, 0.1 wt % or less of repeating units derived from BPA, based on the total weight of the curable composition. Similarly, as used herein, “substantially free of repeating units derived from novolac” means that the curable composition comprises 10 wt % or less, 5 wt % or less, 1 wt % or less, 0.1 wt % or less of repeating units derived from novolac, based on the total weight of the curable composition. In still further embodiments, the curable composition excludes repeating units derived from BPA and/or repeating units derived from novolac.

The curable compositions can include a polymerization inhibitor to prevent gelation during storage and transport. Examples of inhibitors can include, but are not limited to, butylated hydroxytoluene, hydroquinone, benzoquinone, phenol, 4-methoxyphenol, and the like. The inhibitor can be used to scavenge small amounts of free radicals during storage and to improve the shelf stability of the curable compositions.

Colorants such as pigment or dye additives can also be present. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes.

Dyes are generally organic materials and include coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenyl stilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or a combination thereof

The curable compositions can exclude solvent, a dispersant, or a combination thereof. Advantageously, when the curable resin comprises distilled tall oil rosin acid derivatives, distilled tall oil fatty acid derivatives, or a combination thereof, then the curable resins are liquid and workable at room temperature, so a solvent or a dispersant is not needed.

In an exemplary embodiment, a curable composition comprises a curable resin comprising a reaction product of a distilled tall oil rosin acid or a derivative thereof and a fatty acid or a derivative thereof monomeric and/or oligomeric trimethylolpropane triglycidyl ether, monomeric and/or oligomeric pentaerythritol tetraglycidyl ether, or a combination thereof acrylic acid; and a catalyst. The curable composition of the exemplary embodiment additionally comprises a photo initiator, optionally, an energy-curable monomer, oligomer, polymer, or a combination thereof, wherein the energy-curable monomer has at least one terminal functional group comprising an acrylate; and optionally, an energy-curable monomer, a curing synergist, a pigment, or a combination thereof. The energy-curable monomer, oligomer, polymer, or a combination thereof, when present in this exemplary embodiment, includes repeating units derived from 1,4-butanediol diacrylate, 1,6-hexanediol diacrylate,1,6-hexanediol dimethacrylate, 1,9-nonanediol diacrylate, or a combination thereof. In further embodiments of this exemplary embodiment, the curable composition is substantially free of repeating units derived from BPA and/or repeating units derived from novolac. In still further embodiments, the curable composition excludes repeating units derived from BPA and/or repeating units derived from novolac.

A thermoset coating or ink or other compositions (i.e., thermoset) can be obtained by irradiation with actinic radiation at a sufficient wavelength and exposure time. In some embodiments, curing the composition can include injecting the curable composition into a mold, and curing the injected composition at room temperature or elevated temperatures in the mold.

The UV and EB curable compositions can be prepared, applied and cured in a usual manner. Any of known light sources for radiating ultraviolet rays can be used and they are suitably selected according to objects and uses. As the light sources, there are mentioned, for instance, light sources of arc lamp type, flash lamp type, laser type and electrodeless lamp type (microwave). Also, as electron beam accelerators, both the scanning type and the curtain type can be used.

The curable compositions can be used as a coating composition, such as, for example, an adhesive composition or an ink composition. The thermosetting compositions can be used for lithographic inks and varnishes, graphic arts, coatings printed circuit boards, coatings for automotive applications, as well as wood, concrete and plastic coatings.

A method for coating a substrate comprises the steps of applying a coating of the curable composition and curing the curable composition to provide a crosslinked resin via UV and/or EB energy.

### EXAMPLES

In the examples below, the acid number was measured by a Metrohm auto-titrator with KOH solution by ASTM D664. The epoxy equivalent weight (EEW) was determined by titration with perchloric acid in acetic acid.

The details of the examples are contemplated as further embodiments of the described methods and compositions. Therefore, the details as set forth herein are hereby incorporated into the detailed description as alternative embodiments.

### Example 1: Multifunctional Modified DTO-Based Acrylate

Ingevity DTO Altapyne® M-28B (˜28% rosin content, 400.0 g) and fumaric acid (23.7 g) were charged into a 2 L four-neck round bottom flask equipped with an air driven agitator, condenser, nitrogen inlet, and a thermocouple. The mixture was heated to 220° C. for two hours under a blanket of nitrogen. The temperature was adjusted to 80° C. The acid number was measured to be 220 mg KOH/g. Then, 540 g of trimethylolpropane triglycidyl ether (TMPTE) (Sigma-Aldrich) was added along with 2.7 g of triphenylphosphine (TPP). After the exotherm was stabilized, another 2.7 g of TPP was added. The temperature was maintained at 105° C. and the acid number and EEW were monitored where the completion of this reaction was indicated when the acid number was <1 mg KOH/g and EEW ˜445. The temperature was again adjusted to 80° C. Into the same reaction flask, the inhibitor package OH-Tempo (0.06 g) and Cyanox 1790 (0.22 g) were added. This was followed by the addition of acrylic acid (140 g). The temperature was gradually increased to 105° C. while the exotherm was stabilized below 115° C. When the acid number reached 8.1 mg KOH/g the product was cooled to 60° C. and discharged. Viscosity (Brookfield viscometer, spindle s63) 28700 cP at 25° C. and 360 cP at 80° C. Gardner color 6.4.

### Example 2: Multifunctional Unmodified DTO-Based Acrylate

A 1 L four-neck round bottom flask equipped with an air driven agitator, condenser, nitrogen inlet, and a thermocouple was charged with Altapyne® M-28B 250.0 g, 254.5 g of TMPTE (Sigma-Aldrich), and 1.5 g of TPP. The reactants were kept under a blanket of nitrogen and gradually heated to 105° C. When the acid number was <1 mg KOH/g, the temperature was adjusted to 80° C. Next, OH-Tempo (0.03 g), Cyanox 1790 (0.12 g), and acrylic acid (66.7 g) were added. The temperature was gradually increased to 105° C. while the exotherm was stabilized below 115° C. When the acid number reached 14.5 mg KOH/g the product was cooled to 60° C. and discharged. Viscosity (Brookfield viscometer, spindle s63) 4450 cP at 25° C. and 1230 cP at 40° C. Gardner color 6.6.

### Comparative Example 3

In this comparative example, 296 g of AltaMer EP 125 (a tall oil epoxy product) and 75 g of bisphenol A epoxy resin (trade name: EPON 828; from flexion) were charged into a reaction vessel equipped with temperature probe, air inlet and mechanical stirrer. The reaction mixture was heated to 80 C. and then 0.02 g OH tempo, 0.2 g Cyanox 1790, 65.5 g acrylic acid were added into the reactor. The reactor was heated to 105° C. and then 1.0 g TPP was charged. After the exothermic peak, the reaction mixture was cooled down to 107° C. and maintained at that temperature until the reaction mixture had an acid number of 20.5, an EEW of 3540, and a viscosity @100° C./50 RPM of 4.8 poise. 0.14 g THQ inhibitor and 150 g TMPTA monomer are added into the reactor and the reactor was cooled to 40° C. and then discharged.

### Comparative Example 4

Herein, 400 g of AltaMer EP 125, 0.02 g OH tempo, 0.2 g Cyanox 1790, and 47 g acrylic acid were charged into a reaction vessel equipped with temperature probe, air inlet and mechanical stirrer. The reaction mixture was heated to 105 C and then 1.0 g TPP was charged. After the exothermic peak, the reaction mixture was cooled down to 108° C. and maintained at that temperature until the reaction mixture had an acid number of 29.2, an EEW 4632, and a viscosity @50 C/50 RPM of 69 poise. 0.14 g THQ inhibitor and 100 g TMPTA monomer are added into the reactor and the reactor was cooled to 40° C. and then discharged.

### Thermoset of Comparative Example 5

In this typical formulation testing example, 39 g of CN975 (hexafunctional aromatic urethane acrylate oligomer, Sartomer), 59 g of SR238 (1,6-hexanediol diacrylate (HDODA), Sartomer), 0.4 g of a photoinitiator 819 (phenylbis(2,4,6-trimethylbenzoyl) phosphine oxide, Sigma-Aldrich) and 1.6 g of a photoinitiator 1173 (2-hydroxy-2-methyl-1-phenyl-propan-1-one, Sigma-Aldrich) were placed in a flask and a cowles blade mixer was used to homogenize and yield a standard formula, The resulting composition was coated on an alumina substrate at 3 mil using a Mayer rod. The coated films were cured after exposing to a Q-type UV lamp at 200 watt per inch.

### Thermosets of Examples 1-2 and Comparative Examples 3-4

The thermosetting compositions including the products of Examples 1-4 were prepared similarly to the thermosetting composition of Comparative Example 5, except that 20 g of the product from the appropriate Synthesis Example was used instead of the urethane acrylate oligomer. To the product from the Synthesis Example was added 19 g of CN975, 59 g of SR238, 0.4 g of photoinitiator 819, and 1.6 g of photoinitiator 1173. The compositions were coated on an alumina substrate at 3 mil using a Mayer rod. The coated films were cured after exposing to a Q-type UV lamp at 200 watt per inch.

The cured films were subject to the following tests to evaluate its performance. The testing includes tack, adhesion, gloss, hardness, flexibility, water resistance, and stability.

TABLE 1
UV curable coating application results. Fast cure occurred in seconds.
Scale 1-5 where 5 is regarded best performance. Formulation details are given in Example 5.

| Testing formula | Curing | Tack | Adhesion | Stability | Gloss | Hardness | Flexibility |
|---|---|---|---|---|---|---|---|
| Thermoset | Fast | 2 | 4 | 5 | 5 | 2 H | 5 |
| Example 1 | | | | | | | |
| Thermoset | Fast | 2 | 3 | 4 | 5 | HB | 4 |
| Example 2 | | | | | | | |
| Thermoset | Fast | 3 | 4 | 5 | 5 | 4 H | 4 |
| Comparative | | | | | | | |
| Example 3 | | | | | | | |
| Thermoset | Fast | 3 | 5 | 5 | 5 | 4 H | 3 |
| Comparative | | | | | | | |
| Example 4 | | | | | | | |
| Thermoset | Fast | 2 | 3 | 4 | 5 | 2 H | 2 |
| Comparative | | | | | | | |
| Example 5 | | | | | | | |

The cured film was prepared using the formula and film curing condition described above.

The testing methods and the results interpretation used are described as follows. The tape adhesion (ASTM D3359), gloss meter (ASTM D523), pencil hardness (ASTM D3363) Mandrel bend (ASTM D522) were standard methods used to evaluate the adhesion, gloss, hardness, flexibility. Other non-ASTM methods used include the probe tack test to evaluate the tackiness, finger tap method to evaluate the curing speed. The stability test was evaluated by sitting the film at ambient temperature overtime and watch how well the film holds over time. The results are listed for pencil hardness or quantified in a 1-5 scale where 1 indicates the worst and 5 indicate the best.

Table 1 shows the thermosetting compositions of Example 1, which includes modified DTO (fumaric acid adduct) acrylate and Example 2, which includes unmodified DTO acrylate, and thermosetting compositions of Comparative Examples 3-4 and the control Example 5.

To further evaluated the compatibility of the resins we described, a simplified pigmented coating formulation was made and tested. In the typical formulation, 40 g of CN423 (isobornyl methacrylate, Sartomer), 30 g of CN975, 20 g of CN154 (epoxy oligomer, Sartomer), 4 g of a pigment (i.e. Napthol Red or Phthalo Blue) and 3 g of a photoinitiator 1173, 3 g of photoinitiator 819 were placed in a metal can, and 300 g of grinding media was placed in the can. The mixture was placed in a paint shaker and shake for 30 mins before filtering to remove the grinding media. The resulting composition was coated on an alumina substrate at 3 mil using a Mayer rod. The coated films were cured under the UV lamp. The resulting formula was set as a control formula of a pigmented coating system.

A testing formula comprised of 40 g of CN423 (isobornyl methacrylate, Sartomer), 15 g of CN975, 15 g of Example 1, 20 g of CN154 (epoxy oligomer, Sartomer), 4 g of a pigment (i.e. Napthol Red, Phthalo Blue) and 3 g of a photoinitiator 1173, 3 g of photoinitiator 819. And the formula was processed in the same way described above and yielded a testing formulation Both the testing formulation and the standard formulation was compared for its curing speed, cured film adhesion, hardness and stability. No difference was found in both samples.

While several embodiments of the invention have been shown and described herein, it will be understood that such embodiments are provided by way of example only. Numerous variations, changes and substitutions will occur to those skilled in the art without departing from the spirit of the invention. Rather, the present disclosure is to cover all modifications, equivalents, and alternatives falling within the scope of the present disclosure as defined by the following appended claims and their legal equivalents. Accordingly, it is intended that the description and appended claims cover all such variations as fall within the spirit and scope of the invention.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients can be varied to optimize the desired effects, additional ingredients can be added, and/or similar ingredients can be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

What is claimed is:

1. A curable resin comprising a reaction product of:
a distilled tall oil rosin acid or derivative thereof, a distilled tall oil fatty acid or a derivative thereof, or a combination thereof;
a multifunctional glycidyl ether component comprising at least two glycidyl ether groups;
a catalyst; and
a (meth)acrylate terminal functional group precursor; and
wherein the curable resin has at least one terminal functional group comprising (meth)acrylate and is present as a monomer, an oligomer, a polymer, or a combination thereof.

2. The curable resin of claim 1, further comprising a rosin acid or derivative thereof, a fatty acid or a derivative thereof, or a combination thereof, wherein the rosin acid or derivative thereof and the fatty acid or a derivative thereof are each independently derived from at least one of a gum tree rosin, a wood rosin, a softwood rosin, a hardwood rosin, a natural oil, or a combination thereof.

3. The curable resin of claim 1, wherein the rosin acid derivative comprises of a mixture of one, two, or three carboxylic acid groups and wherein the fatty acid derivative comprises of a mixture of one, two, or three carboxylic acid groups.

4. The curable resin of claim 1, wherein the rosin acid derivative comprises an adduct formed by a cycloaddition reaction of a rosin acid, the fatty acid derivative comprises an adduct formed by a cycloaddition reaction of a fatty acid, or a combination thereof.

5. The curable resin of claim 1, comprising a rosin acid derivative and a fatty acid derivative, wherein the rosin acid derivative comprises an adduct formed by a cycloaddition reaction of a rosin acid, and the fatty acid derivative comprises an adduct formed by a cycloaddition reaction of a fatty acid.

6. The curable resin of claim 1, comprising a rosin acid derivative and a fatty acid derivative, wherein the rosin acid derivative comprises a disproportionated rosin, a maleated rosin, a fumarated rosin, itaconic acid adduct or anhydride adduct, an acrylic acid adduct, a dimer acid, or a combination thereof, and the fatty acid derivative comprises a maleated fatty acid, a fumarated fatty acid adduct, acrylic-acid fatty acid adduct, an itaconic acid or anhydride fatty acid adduct, a dimer fatty acid, or a combination thereof.

7. The curable resin of claim 1, wherein the glycidyl ether component comprises a monomer, an oligomer, or a polymer.

8. The curable resin of claim 1, wherein the glycidyl ether component comprises monomeric trimethylolpropane triglycidyl ether, oligomeric or polymeric trimethylolpropane triglycidyl ether, monomeric pentaerythritol tetraglycidyl ether, oligomeric or polymeric pentaerythritol tetraglycidyl ether, or a combination thereof.

9. The curable resin of claim 1, wherein the curable resin excludes repeating units derived from bisphenol A.

10. A method for preparing a curable resin of claim 1, comprising the steps of:
reacting a distilled tall oil rosin acid or a derivative thereof and/or a DTO distilled tall oil fatty acid or derivative thereof, with a multifunctional glycidyl ether component comprising at least two glycidyl ether groups in the presence of a catalyst to provide a ring-opened first intermediate; and
reacting the ring-opened first intermediate with a (meth)acrylate terminal functional group precursor in the presence of a catalyst to provide the curable resin.

11. A curable composition comprising:
at least one curable resin of claim 1;
a catalyst;
optionally, an energy-curable monomer, oligomer, polymer, an auxiliary curable resin, a photo initiator, a synergist, a pigment, or a combination thereof.

12. The curable composition of claim 11, wherein the energy-curable monomer comprises a bifunctional aliphatic monomer, a multifunctional monomer, or a combination thereof, and the energy-curable oligomer, polymer, or a combination thereof is derived from at least one of a bifunctional aliphatic monomer, a multifunctional monomer, or a combination thereof.

13. The curable composition of claim 11, wherein the curable composition excludes repeating units derived from bisphenol A, novolac, or a combination thereof

14. The curable composition of claim 11, wherein the energy-curable monomer comprises at least one of 1,4-butanediol diacrylate, 1,6-hexanediol diacrylate, 1,9-nonanediol diacrylate, or a combination thereof, and the energy-curable oligomer, polymer, or a combination thereof is derived from at least one of 1,4-butanediol diacrylate, 1,6-hexanediol diacrylate, 1,9-nonanediol diacrylate, or a combination thereof.

15. The curable composition of any one of claim 11, wherein the auxiliary curable resin comprises a urethane acrylate.

16. The curable composition of any one of claim 11, wherein the curable composition comprises at least one of about 10 wt % or less of bisphenol A resin, a novolac resin, or a combination thereof.

17. A thermoset comprising the curable composition of claim 11.

18. A coating composition comprising the curable composition of claim 11, wherein the coating is an adhesive coating or an ink dispersion.

19. An article comprising the thermoset of claim 17.

20. An article comprising the coating composition of claim 18.
